(19) United States
(12) Patent Application Publication
(10) Pub. No.: US 2026/0039166 A1
(43) Pub. Date: Feb. 5, 2026

(54) BLOWER MOTOR FOR VEHICLES

(71) Applicant: ILJIN GLOBAL HOLDINGS CO., LTD., Seoul (KR)

(72) Inventors: Woon Ju LEE, Seoul (KR); Jai Seong CHO, Seoul (KR); Ki Chang SHIM, Seoul (KR); Sung Dong CHANG, Seoul (KR); Young Jun HAHM, Seoul (KR)

(73) Assignee: ILJIN GLOBAL HOLDINGS CO., LTD., Seoul (KR)

(21) Appl. No.: 19/354,943

(22) Filed: Oct. 10, 2025

Related U.S. Application Data
(63) Continuation of application No. PCT/KR2024/004789, filed on Apr. 11, 2024.

(30) Foreign Application Priority Data
Apr. 12, 2023 (KR) 10-2023-0048447
Apr. 12, 2023 (KR) 10-2023-0048451
Apr. 12, 2023 (KR) 10-2023-0048452
Apr. 12, 2023 (KR) 10-2023-0048454
Aug. 18, 2023 (KR) 10-2023-0108501

(51) Int. Cl. H02K 5/10

(52) U.S. Cl. CPC H02K 5/10; H02K 2205/09

(57) ABSTRACT

A blower motor for a vehicle includes: a rotor module, a stator module, and a PCB board; and a lower housing on which the rotor module, the stator module, and the PCB board are mounted. The lower housing is configured to watertightly divide a space in which the rotor module and the stator module are mounted and a space in which the PCB substrate is mounted, and the lower housing includes a drainage channel formed to extend along an upper surface of the lower housing.

### CROSS-REFERENCE TO RELATED APPLICATIONS

This application is a continuation of International Application No. PCT/KR2024/004789 filed on Apr. 11, 2024, which claims priority to Korean Patent Application No. 10-2023-0048447 filed on Apr. 12, 2023, Korean Patent Application No. 10-2023-0048451 filed on Apr. 12, 2023, Korean Patent Application No. 10-2023-0048452 filed on Apr. 12, 2023, Korean Patent Application No. 10-2023-0048454 filed on Apr. 12, 2023, and Korean Patent Application No. 10-2023-0108501 filed on Aug. 18, 2023, the entire contents of which are herein incorporated by reference.

### Technical Field

The present invention relates to a blower motor for a vehicle, and more particularly, to a blower motor for a vehicle, which has a structure in which a first space in which a rotor module and a stator module are mounted and a second space in which a PCB board is mounted are watertightly divided, and which is capable of discharging moisture in the first space to the outside and preventing the moisture from entering the second space in which the PCB board is mounted.

### Background Art

An air conditioning system of a vehicle may include a heater to warm the interior of the vehicle, an air conditioner to cool the interior air, or the like. When the air conditioner or the heater is in operation, the air conditioning system may operate by blowing cooled or heated air into the interior of the vehicle. This blowing may be accomplished through a blower motor.

Typically, a blower motor sucks in outside air and delivers the outside air to the interior of the vehicle, thereby creating ventilation. This intake of the outside air may be achieved by driving the blower motor to rotate a fan.

In this blower motor structure, at least a portion of the inside of a motor needs to be exposed to the outside to allow outside air to be sucked into the motor, which may lead to moisture entering the motor. Conventional blower motors may have a downward-extending drain hole provided in a housing to allow moisture entering the motor to fall and discharge to the outside.

### SUMMARY

### Technical Problem

The present invention is devised to solve the problem that a conventional drainage structure of a blower motor for a vehicle is not suitable when the blower motor is adopted as a structure in which a first space in which a rotor module and a stator module are mounted and a second space in which a PCB board is mounted are watertightly divided, and an object of the present invention is to provide a blower motor for a vehicle that is capable of discharging moisture in the first space to the outside in the above-described watertight divided structure and preventing the moisture from entering the second space in which the PCB board is mounted.

### Technical Solution

A blower motor 1 for a vehicle according to one embodiment of the present invention includes: a rotor module 240, a stator module 230, and a PCB board; and a lower housing 210 on which the rotor module 240, the stator module 230, and the PCB board are mounted wherein the lower housing 210 is configured to watertightly divide a space in which the rotor module 240 and the stator module 230 are mounted and a space in which the PCB substrate is mounted, and the lower housing 210 includes a drainage channel 222 formed to extend along an upper surface of the lower housing 210.

One end of the drainage channel 222 may be configured to be in fluid communication with a space in which the rotor module 240 and the stator module 230 are mounted, and the other end of the drainage channel 222 may be formed at an edge end of the upper surface of the lower housing 210.

Also, the drainage channel 222 may be formed by forming a concave groove in a negative shape in the upper surface of the lower housing 210.

Furthermore, according to one embodiment of the present invention, the rotor module 240 and the stator module 230 may be disposed at a center of the lower housing 210, and a plurality of drainage channels 222 may be provided, and the plurality of drainage channels 222 may be disposed spaced apart from each other along an outer circumference of the space in which the rotor module 240 and the stator module 230 are mounted.

Moreover, one end of the drainage channel 222 may be configured to be in fluid communication with the space in which the rotor module 240 and the stator module 230 are mounted, and the other end of the drainage channel 222 may be configured to be in fluid communication with the outside, and the drainage channel 222 may be configured to not allow air to flow in the drainage channel 222 when the blower motor 1 for a vehicle is in operation. The drainage channel 222 may be configured to allow a flow of moisture in the drainage channel 222 when the blower motor 1 for a vehicle is not in operation.

The drainage channel 222 may be a Tesla valve structure.

Also, the blower motor 1 for a vehicle according to one embodiment of the present invention may further include a drain cover 221 configured to cover an upper portion of the drainage channel 222.

A plate 225 having the drainage channel 222 formed on an upper surface may be coupled to the lower housing 210 in an embedded manner.

Furthermore, the blower motor 1 for a vehicle according to one embodiment of the present invention may further include a flange 300 configured to accommodate the lower housing 210 therein. The other end of the drainage channel 222 is in fluid communication with the outside through a drainage channel formed in the flange 300.

### Advantageous Effects

According to one embodiment of the present invention, a drainage passage is formed to extend along an upper surface of a lower housing in a structure in which a first space in which a rotor module and a stator module are mounted and a second space in which a PCB board is mounted are watertightly divided so that the moisture inside a motor can be discharged to the outside through the drainage passage, and the moisture inside the motor can be prevented from entering the second space.

Also, according to one embodiment of the present invention, the drainage passage is configured so as not to allow air to flow in the drainage passage when the blower motor for a vehicle is in operation, thereby providing a drainage function while at the same time preventing the air flow generated by a blower from being lost through the drainage passage.

### DESCRIPTION OF DRAWINGS

FIG. 1 is a perspective view of a blower motor according to one embodiment of the present invention.

FIG. 2 is an exploded perspective view of the blower motor shown in FIG. 1.

FIG. 3 is an exploded perspective view of a motor module shown in FIG. 2.

FIG. 4 is a view showing a lower housing and a housing damper shown in FIG. 3.

FIG. 5 is a view showing a lower surface of the lower housing shown in FIG. 4.

FIG. 6 is a view for describing a clamp, a lower housing, and a flange according to one embodiment of the present invention.

FIG. 7 is a cross-sectional view of the blower motor shown in FIG. 1.

FIG. 8 is a view showing the lower housing in which a drain cover is removed (for illustration purposes) to reveal a drainage channel.

FIG. 9 is a view showing the lower housing in which the drain cover is fully mounted.

FIGS. 10A and 10B are views for describing the Tesla valve structure of a drainage channel according to one embodiment of the present invention.

FIG. 11 shows a drainage channel component according to one embodiment of the present invention.

### DETAILED DESCRIPTION

The advantages and features of the present invention, and the methods for achieving them, will become clearer with reference to the embodiments described in detail below together with the accompanying drawings. However, the present invention is not limited to the embodiments disclosed below, but may be implemented in various different forms. The present embodiments are provided only to ensure that the disclosure of the present invention is complete and to fully inform those skilled in the art of the present invention of the scope of the invention, and the present invention is defined only by the scope of the claims. The same reference numerals refer to like elements throughout the specification.

When an element is referred to as being “above” or “on” another element, it includes not only being directly on the other element, but also having other elements intervening therewith. Conversely, when an element is referred to as being “directly on” or “just above,” it indicates that there are no intervening elements. “And/or” includes each and every combination of one or more of the mentioned items.

Spatially relative terms such as “below,” “beneath,” “lower,” “above,” and “upper” may be used to easily describe the relationship between one component and another, as shown in the drawings. Spatially relative terms should be understood to include different orientations of the element during use or operation in addition to the orientations shown in the drawings. The same reference numerals throughout the specification refer to the same components.

Although the terms first, second, and the like are used to describe various components and/or sections, these components and/or sections are not limited by these terms. These terms are merely used to distinguish one component or section from another. Accordingly, it should be understood that a first component or a first section referred to below may also be a second component or a second section within the technical concept of the present invention.

The embodiments described in the present specification will be described with reference to plan views and cross-sectional views, which are ideal schematic drawings of the present invention. Accordingly, the shapes of the illustrated drawings may be modified due to manufacturing techniques and/or tolerances. Accordingly, the embodiments of the present invention are not limited to the specific shapes illustrated, but also include changes in shapes resulting from the manufacturing process. Accordingly, the regions shown in the drawings have schematic properties, and the shapes of the regions shown in the drawings are intended to illustrate specific shapes of regions of the configuration, and are not intended to limit the scope of the invention.

Hereinafter, a preferred embodiment of the present invention will be described in more detail with reference to the attached drawings.

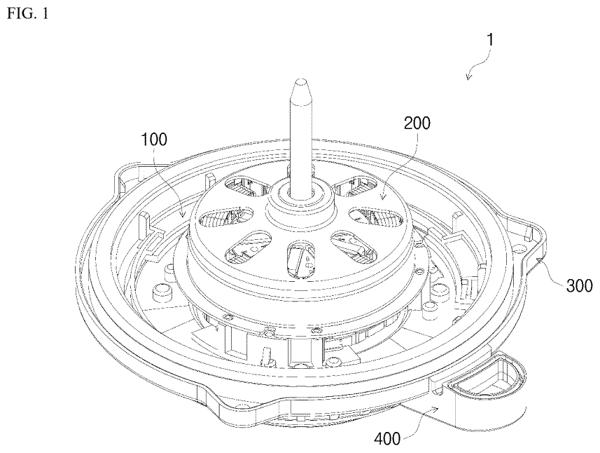

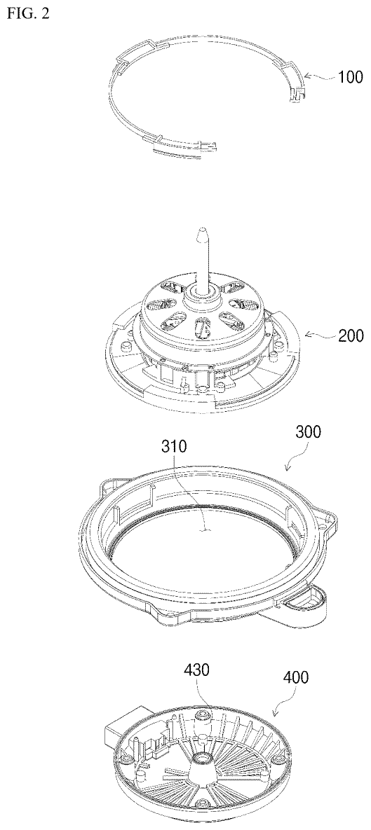

FIG. 1 is a perspective view of a blower motor according to one embodiment of the present invention. FIG. 2 is an exploded perspective view of the blower motor shown in FIG. 1.

Referring to FIGS. 1 and 2, a blower motor 1 according to one embodiment of the present invention may include a clamp 100, a motor module 200, a flange 300, and a cover 400. The clamp 100 is a component that fixes the motor module 200 to the flange 300 and may be, for example, in a ring shape with a portion omitted in a circumferential direction. First, the motor module 200 will be described as follows.

As described above, the blower motor 1 for a vehicle according to one embodiment of the present invention may have a structure in which a first space in which a rotor module 240 and a stator module 230 are mounted and a second space in which a PCB board is mounted are watertightly divided. The drainage structure according to one embodiment of the present invention may be a drainage structure suitable for the watertight divided structure.

Hereinafter, the watertight divided structure of the present invention will be first described, followed by the drainage structure of the present invention.

### 1. Watertight Divided Structure

As one component of the watertight divided structure, first the motor module 200 will be described as follows.

The motor module 200 is a module that receives electrical energy and drives a motor (more specifically, a rotor) to rotate a cooling wheel (not shown) to generate air flow.

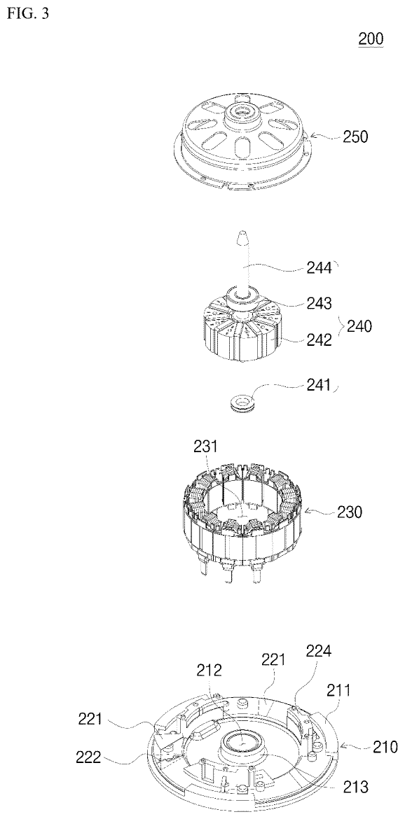

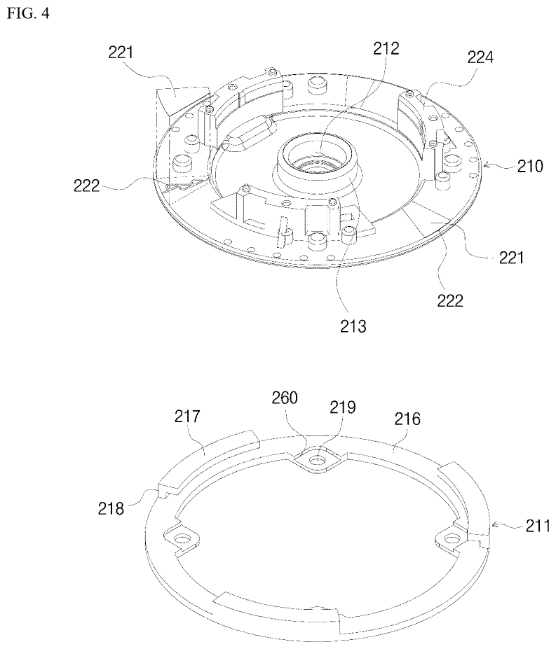

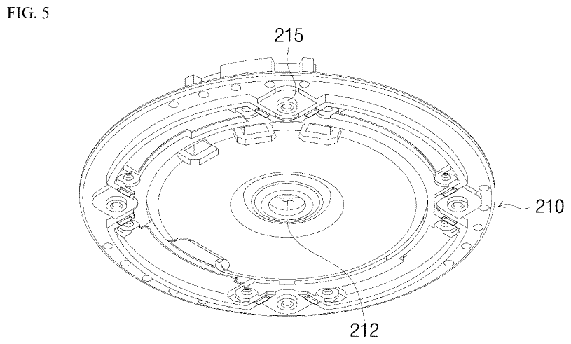

FIG. 3 is an exploded perspective view of the motor module shown in FIG. 2. FIG. 4 is a view for explaining a lower housing and a housing damper shown in FIG. 3. FIG. 5 is a view for explaining the lower housing shown in FIG. 4.

Referring to FIGS. 3 to 5, the motor module 200 according to one embodiment of the present invention may include a lower housing 210, the stator module 230, the rotor module 240, and an upper housing 250.

First, the rotor module 240 includes a shaft 244, a rotor 242 that is press-fitted and fixed to the shaft 244, a first bearing 241 that is press-fitted and fixed to the shaft 244 to form an axis center and perform a function of reducing rotational resistance, and a second bearing 243.

The rotor 242 may be formed in a cylindrical shape and may be implemented with a structure in which a plurality of magnets are inserted therein. For example, each of the magnets may be a permanent magnet with a rectangular structure and has a function of generating magnetic flux.

Subsequently, the stator module 230, which is one of components of the motor module 200, is a module for electromagnetically rotating the rotor 242 and may have a hollow cylindrical shape having a through hole 231 so that the rotor 242 is disposed therein.

Subsequently, the lower housing 210 is a component that covers lower portions of the rotor module 240 and the stator module 230, and the upper housing 250 is a component that covers upper portions of the rotor module 240 and the stator module 230.

According to one embodiment of the present invention, the motor module 200 may be assembled by arranging the rotor module 240 and the stator module 230 on the lower housing 210 and finally coupling the upper housing 250 to the lower housing 210.

Subsequently, the lower housing 210, which is one component of the motor module 200, and a housing damper 211 coupled to the lower housing 210 will be described in more detail. FIG. 4 is a view for explaining the lower housing and the housing damper shown in FIG. 3, and FIG. 5 is a view showing a lower surface of the lower housing illustrated in FIG. 4.

Referring to FIGS. 4 and 5, the lower housing 210 functions as a structure on which most components of the blower motor 1 are mounted. That is, as described above, the rotor module 240, the stator module 230, and the upper housing 250 are mounted on an upper surface of the lower housing 210, and the PCB board (not shown) and the cover 400 are mounted on a lower surface of the lower housing 210.

In the present invention, in the structure as above, the housing damper 211 is disposed between the lower housing 210 and the flange 300 so that vibrations generated in the blower motor 1, particularly the rotor module 240, is attenuated through the housing damper 211 disposed between the lower housing 210 and the flange 300 before being transmitted to the vehicle body through the flange 300 via the lower housing 210.

For example, the lower housing 210 may have a disc-shaped shape. First, with respect to the mounting of the rotor module 240, (as shown in FIG. 4) a central through hole 212 is formed at a center of the lower housing 210 and extends to pass through an upper surface to a lower surface thereof. The shaft 244 is inserted into the central through hole 212 and extends to pass therethrough. In addition, a ring-shaped central protruding portion 213 is formed in the lower housing 210 and protrudes upward while surrounding the central through hole 212. Accordingly, the first bearing 241 of the rotor module 240 is disposed in the central protruding portion 213 so that the rotor module 240 is mounted on the lower housing 210.

Subsequently, with respect to the mounting of the stator module 230, for example, a plurality of mounting posts 224 may be formed on the upper surface of the lower housing 210 in the circumferential direction concentrically with the central through hole 212, and for example, the mounting posts 224 may be disposed to be spaced apart from each other. The mounting posts 224 are used for coupling the upper housing 250 to the lower housing 210, and at the same time, functions to surround the stator module 230 to fix the stator module 230 on the lower housing 210 in a horizontal direction. In other words, the stator module 230 is disposed in a space partially surrounded by the mounting posts 224 of the lower housing 210 so that the stator module 230 is mounted on the lower housing 210.

Subsequently, the PCB board may be attached to the lower surface of the lower housing 210, for example, using a double-sided tape or an adhesive.

Subsequently, as shown in FIG. 5, one or more downward protruding portions 215 protruding downward for coupling to the cover 400 may be formed on the lower surface of the lower housing 210. For example, the downward protruding portion 215 may be disposed spaced a predetermined interval apart in the circumferential direction of the lower housing 210. The cover 400 may have a concave shape with an open top and forming an internal space. One or more upward protruding portions 430 protruding upward for coupling to the lower housing 210 may be formed on an upper surface of the cover 400 at positions corresponding to the downward protruding portion 215 of the lower housing 210. Accordingly, although the lower surface of the lower housing 210 and the upper surface of the cover 400 are spaced apart from each other due to the concave shape of the cover 400, each of the downward protruding portions 215 and each of the upward protruding portions 430 are coupled in a groove/protrusion structure-type fitting manner so that the cover 400 is coupled to the lower housing 210.

In this way, in the present invention, the rotor module 240 and the stator module 230 are mounted on the upper surface of the lower housing 210, and the PCB board is mounted on the lower surface of the lower housing 210. Therefore, (1) a first space in which the rotor module 240 and the stator module 230 are mounted and (2) a second space in which the PCB board is mounted are physically separated based on the lower housing 210. In addition, the housing damper 211 of the present invention performs a function of sealing the second space in which the PCB board is mounted in a watertight manner, thereby preventing moisture or foreign substances generated in the first space in which the rotor module 240 and the stator module 230 are disposed from entering the second space in which the PCB board is mounted. This will be described in more detail below.

As shown in FIG. 4, the housing damper 211 may be configured to include a ring-shaped annular portion 216 formed to cover an edge of the lower surface of the lower housing 210, a first protruding portion 218 extending upward from an upper surface of the annular portion 216, and a second protruding portion 217 extending inward in a radial direction from an upper end of the first protruding portion 218. In this case, the housing damper 211 may be formed, for example, by insert-molding with a rubber material.

Meanwhile, the flange 300 is a component for accommodating the motor module 200 and connecting the motor module 200 to, for example, a duct of an air conditioning system. The flange 300 may be formed in a ring shape so that at least a portion of the motor module 200 is disposed inside the flange 300. For example, a through hole 310 is formed at a center of the flange 300, and the through hole 310 of the flange 300 may have a circular shape. After the motor module 200 is disposed in the through hole 310 of the flange 300, the clamp 100 may be disposed on the motor module 200 so that the motor module 200 is fixed on the flange 300.

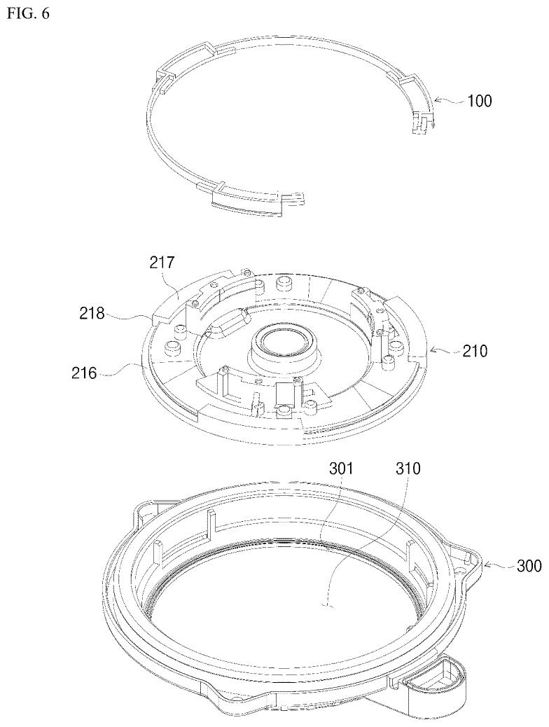

For example, as shown in FIG. 6, a seating portion 301 is formed on an inner circumferential surface forming the through hole 310 to protrude inward in a radial direction and to cause the housing damper 211 to be seated thereon, and as a portion of a lower surface of the annular portion 216 of the housing damper 211 is seated on an upper surface of the seating portion 301, the lower housing 210 is mounted on the flange 300.

According to one embodiment of the present invention, the annular portion 216 of the housing damper 211 is formed to completely cover an edge of the lower surface of the lower housing 210 in the circumferential direction, and has a ring shape extending further outward in the radial direction than an outer circumferential surface of the lower housing 210. In addition, the first protruding portion 218 protrudes upward from the upper surface of the annular portion 216, and the second protruding portion 217 protrudes inward in the radial direction from the upper end portion of the first protruding portion 218.

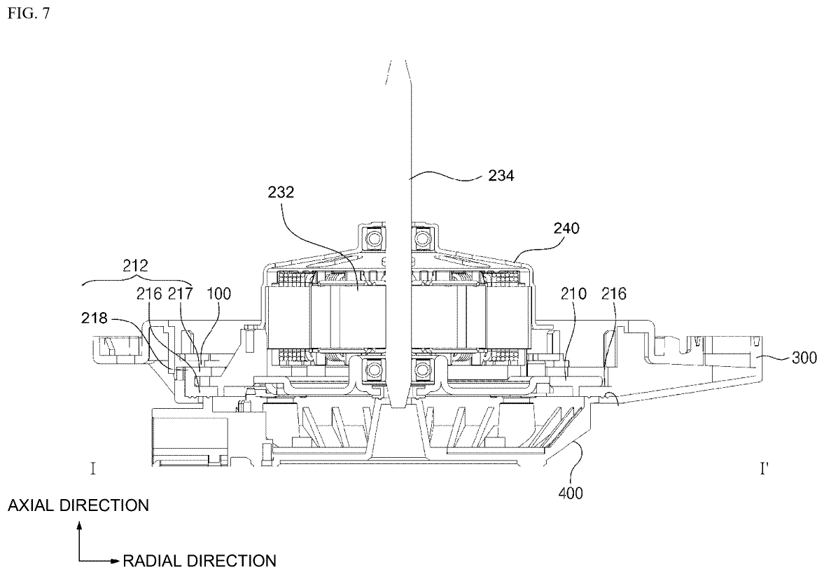

Accordingly, as shown in FIGS. 6 and 7, the lower surface of the annular portion 216 comes into contact with the upper surface of the seating portion 301 of the flange 300 in the circumferential direction, and an outer circumferential surface of the annular portion 216 comes into contact with the inner circumferential surface of the flange 300. In addition, the lower surface of the annular portion 216 comes into contact with the cover 400 in the circumferential direction.

Meanwhile, in the related art, in order for moisture or foreign substances generated in a space above the upper surface of the lower housing 210 to enter a space formed by the cover 400 below the lower surface of the lower housing 210, the moisture or foreign substances need to flow down along the inner circumferential surface of the flange 300 and the upper surface of the seating portion 301 and then enter a gap between the cover 400 and the lower housing 210. However, as described above, in the present invention, the housing damper 211 is in contact with the inner circumferential surface of the flange 300 and the upper surface of the seating portion 301 in the circumferential direction and is in contact with the cover 400 in the circumferential direction as a whole so that the space formed by the cover 400 is sealed and the moisture or foreign substances are difficult to enter the space.

Referring to FIG. 6, the clamp 100 may be a ring shape with a portion in the circumferential direction omitted to have elasticity outward in the radial direction. Accordingly, after a lower surface of the housing damper 211 of the motor module 200 is seated in the seating portion 301 of the through hole 310, and the motor module 200 is disposed on the flange 300, the clamp 100 may be compressed inward in the radial direction and may be inserted between a protrusion of the inner circumferential surface of the flange 300 and an upper surface of the housing damper 211. The inserted clamp 100 may expand outward in the radial direction due to an elastic force so that the motor module 200 is finally fixed to the flange by the clamp 100 in a vertical direction.

Additionally, referring to FIGS. 2, 4, and 5 of the present invention, a step portion 260 may be additionally formed on the annular portion 216 of the housing damper 211 to cover a downward protruding portion 215 formed on the lower surface of the lower housing 210. A through hole 219 may be formed in the step portion 260 so that a protrusion formed on the downward protruding portion 215 may extend to pass therethrough and may be coupled to an upward protruding portion of the cover. Accordingly, when the downward protruding portion 215 is coupled to the upward protruding portion 430, the step portion 260 covering the downward protruding portion 215 is disposed between the downward protruding portion 215 and the upward protruding portion 430. Accordingly, moisture or foreign substances may be prevented from flowing down along a coupling portion between the downward protruding portion 215 and the upward protruding portion 430 by the step portion.

### 2. Drainage Structure

According to one embodiment of the present invention, the blower motor 1 for a vehicle may further include a drainage channel 222 as a drainage structure for discharging moisture that may exist inside the motor, particularly in the rotor module 240 or the stator module 230, to the outside.

(As described above), the present invention may be structured to have a watertight partition structure, with the first space in which the rotor module 240 and the stator module 230 are mounted and the second space in which the PCB is mounted. This structure prevents moisture or foreign matter entering the first space from the outside from entering the second space in which the PCB is mounted. While the lower housing and the housing damper have been described as examples of the watertight partition structure of the present invention, it should be understood that the watertight partition structure of the present invention is not limited to these embodiments.

In this watertight partition structure, according to one embodiment of the present invention, the drainage channel 222 is not formed as a through-hole structure extending downward through the lower housing 210, but rather extends along the upper surface of the lower housing 210 to facilitate air flow. This is because moisture inside the motor may be more reliably prevented from entering the space in which the PCB is mounted during the drainage process.

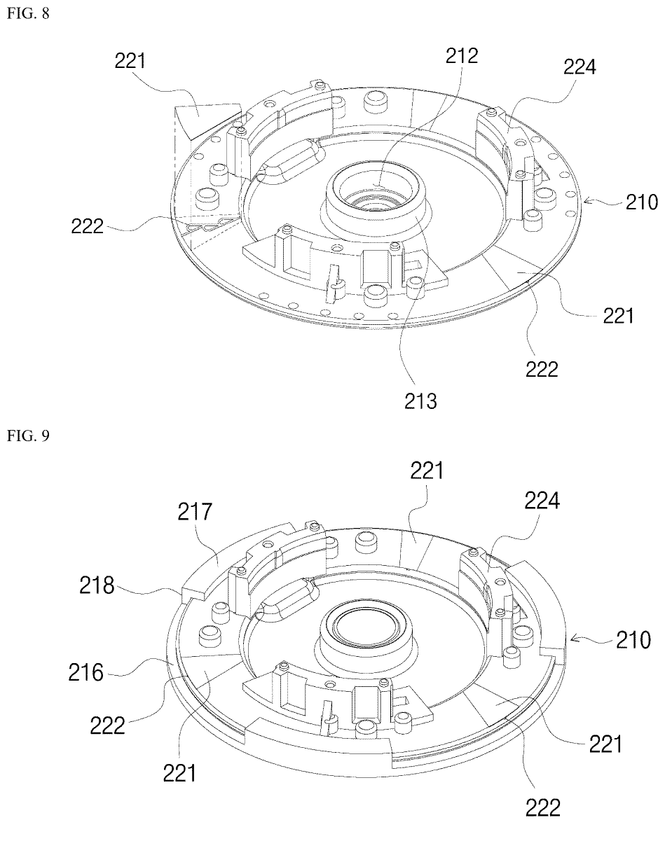

FIG. 8 is a view showing the lower housing in which the drain cover is removed (for illustration purposes) to reveal the drainage channel. FIG. 9 is a view showing the lower housing in which the drain cover is fully mounted.

Referring to FIG. 8, for example, one end of the drainage channel 222 may be configured to be in fluid communication with the space in which the rotor module 240 and the stator module 230 are mounted, and the other end of the drainage channel 222 may be formed at the edge of the upper surface of the lower housing 210. For example, the drainage channel 222 may be formed by forming a concave groove engraved on the upper surface of the lower housing 210.

In addition, in a structure in which the rotor module 240 and the stator module 230 (as shown in FIG. 3) are disposed at the center of the lower housing 210, a plurality of drainage channels 222 (as shown in FIG. 8) may be configured for smoother drainage, and the plurality of drainage channels 222 may be disposed spaced apart from each other along the outer circumference of the space in which the rotor module 240 and the stator module 230 are mounted.

Additionally, the blower motor 1 for a vehicle may further include a drain cover 221 configured to cover the upper portion of the drainage channel 222. For example, the drain cover 221 may be formed in a plate shape and may be structured to cover the upper portion of the lower housing 210 in which the drainage channel 222 is formed. For reference, FIG. 8 shows three drainage channels 222 and drain covers 221 that are spaced apart from each other, and one drain cover 221 is shown disassembled to show the drainage channel 222.

According to one embodiment of the present invention, the drainage channel 222 may be configured to prevent loss of air flow generated by the blower when the blower motor 1 for a vehicle operates. For example, the drainage channel 222 according to one embodiment of the present invention may have a Tesla valve structure. One end of the drainage channel 222 may be configured to be in fluid communication with the first space (in which the rotor module 240 and stator module 230 are mounted), and the other end may be configured to be in fluid communication with the outside.

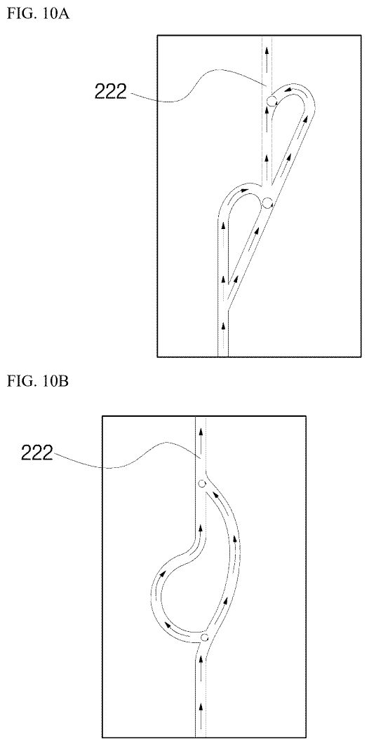

The Tesla valve structure is a known technology that responds to the flow of fluid. That is, when the fluid flows slowly, the fluid may pass in both directions without turbulence or obstruction. However, when the fluid flows at a predetermined speed or higher, the flow is blocked by vortices, as shown in FIGS. 10A and 10B.

When the blower motor 1 for a vehicle is in operation, the pressure of the first space (in which the rotor module 240 and the stator module 230 are mounted) becomes higher than the external pressure. Therefore, since the drainage channel 222 of the Tesla valve structure according to one embodiment of the present invention has one end in fluid communication with the first space (in which the rotor module 240 and the stator module 230 are mounted) and the other end in fluid communication with the outside, when the blower motor 1 for a vehicle is in operation, the Tesla valve structure operates with the same characteristic as a closed valve so that the air flow to the outside is extremely small. On the other hand, when the blower motor 1 for a vehicle is not in operation, since there is no pressure difference between the first space and the outside, the Tesla valve structure operates with the same characteristic as an open valve so that, when there is moisture in the first space, the moisture flows out to the outside through the Tesla valve structure. For example, due to the nature of the blower motor for a vehicle, moisture may be present inside the motor due to condensation caused by temperature differences and moisture contained in the air drawn into the blower under abnormal conditions. This moisture is discharged to the outside through the Tesla valve structure when the blower motor 1 for a vehicle is not in operation.

The fluid velocity at which the Tesla valve structure operates with characteristics similar to a closed valve is determined by adjusting the width and shape of the flow path. The example Tesla valve structure shown in FIGS. 10A and 10B needs to be understood as an example, and the Tesla valve structure according to the present invention is not limited to the Tesla valve structure shown in FIGS. 10A and 10B.

Additionally, according to one embodiment of the present invention, the drainage channel 222 may be provided as a separate component, built into the lower housing 210.

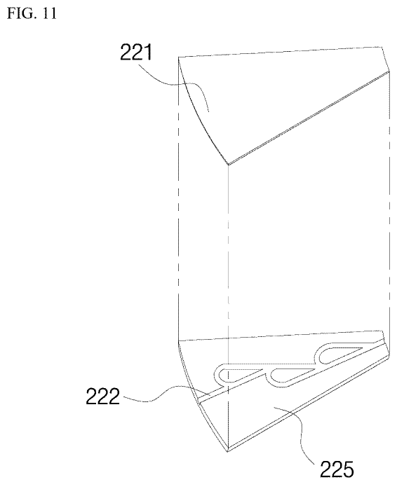

FIG. 11 shows a drainage channel component according to one embodiment of the present invention. As shown in FIG. 11, the drainage channel component may be composed of, for example, a plate 225 having the drainage channel 222 formed on its upper surface and the drain cover 221 covering the plate 225. The plate 225 may be built into a groove formed in the upper surface of the lower housing 210.

Although the present invention has been described with reference to the above embodiments, those skilled in the art will understand that various modifications and changes can be made to the present invention without departing from the spirit and scope of the present invention as defined in the following claims. Furthermore, the embodiments disclosed in the present invention are not intended to limit the technical idea of the present invention, and all technical ideas falling within the scope of the following claims and equivalents thereof should be construed as being included within the scope of the rights of the present invention.

What is claimed is:

1. A blower motor (1) for a vehicle, comprising:
a rotor module (240), a stator module (230), and a PCB board; and
a lower housing (210) on which the rotor module (240), the stator module (230), and the PCB board are mounted,
wherein the lower housing (210) is configured to watertightly divide a space in which the rotor module (240) and the stator module (230) are mounted and a space in which the PCB board is mounted, and
the lower housing (210) includes a drainage channel (222) formed to extend along an upper surface of the lower housing (210).

2. The blower motor (1) for a vehicle of claim 1, wherein one end of the drainage channel (222) is configured to be in fluid communication with a space in which the rotor module (240) and the stator module (230) are mounted, and the other end of the drainage channel (222) is formed at an edge end of the upper surface of the lower housing (210).

3. The blower motor (1) for a vehicle of claim 1, wherein the drainage channel (222) is formed by forming a concave groove in a negative shape in the upper surface of the lower housing (210).

4. The blower motor (1) for a vehicle of claim 2, wherein the rotor module (240) and the stator module (230) are disposed at a center of the lower housing (210), and
a plurality of drainage channels (222) are provided, and the plurality of drainage channels (222) are disposed spaced apart from each other along an outer circumference of the space in which the rotor module (240) and the stator module (230) are mounted.

5. The blower motor (1) for a vehicle of claim 1, wherein one end of the drainage channel (222) is configured to be in fluid communication with the space in which the rotor module (240) and the stator module (230) are mounted, and the other end of the drainage channel (222) is configured to be in fluid communication with the outside, and the drainage channel (222) is configured to not allow air to flow in the drainage channel (222) when the blower motor (1) for a vehicle is in operation.

6. The blower motor (1) for a vehicle of claim 5, wherein the drainage channel (222) is configured to allow a flow of moisture in the drainage channel (222) when the blower motor (1) for a vehicle is not in operation.

7. The blower motor (1) for a vehicle of claim 6, wherein the drainage channel (222) is a Tesla valve structure.

8. The blower motor (1) for a vehicle of claim 3, further comprising a drain cover (221) configured to cover an upper portion of the drainage channel (222).

9. The blower motor (1) for a vehicle of claim 1, wherein the drainage channel (222) is formed to extend in a lateral direction.

10. The blower motor (1) for a vehicle of claim 1, wherein a plate (225) having the drainage channel (222) formed on an upper surface is coupled to the lower housing (210) in an embedded manner.

11. The blower motor (1) for a vehicle of claim 5, further comprising a flange (300) configured to accommodate the lower housing (210) therein,
wherein the other end of the drainage channel (222) is in fluid communication with the outside through a drainage channel formed in the flange (300).
